(19) United States
(12) Patent Application Publication
(10) Pub. No.: US 2006/0244579 A1
(43) Pub. Date: Nov. 2, 2006

(54) Device and method for determining an orientation of a semitrailer or trailer

(75) Inventor: Markus Raab, Kirchhardt (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/559,377

(22) PCT Filed: May 25, 2004
(86) PCT No.: PCT/EP04/05590

§ 371 Date: Jun. 13, 2006

(30) Foreign Application Priority Data
Jun. 6, 2003 (DE) 103 26 190.7

(51) Int. Cl. B60Q 1/00

(52) U.S. Cl. 340/438

(57) ABSTRACT

In an apparatus or a method for determining a spatial alignment of a semitrailer or trailer which is connected to a prime mover, sensors are provided which are arranged on the prime mover in order to produce sensor signals which describe the spatial alignment of the semitrailer or trailer relative to the prime mover, wherein the sensors detect contours of the semitrailer or trailer. Furthermore, an evaluation unit is provided which uses the sensor signals to determine at least one angle variable which describes an angle between the prime mover and the semitrailer or trailer. The sensor signals include image information from at least one of a two-dimensional representation and an image of a linear sub-area of the detected contours of the semitrailer or trailer. The evaluation unit determines the at least one angle variable on the basis of the image information by evaluating the rate of change of geometric characteristics of the at least one of the two-dimensional representation and the image.

### BACKGROUND AND SUMMARY OF THE INVENTION

The invention relates to an apparatus and a method for determining the spatial alignment of a semitrailer or trailer which is connected to a prime mover. The apparatus comprises sensor means, which are arranged in the prime mover, for generating sensor signals which describe the spatial alignment of the semitrailer or trailer relative to the prime mover, with the sensor means detecting contours on the semitrailer or trailer.

DE 199 01 953 A1 discloses an apparatus and a method for determining the distance between a motor vehicle and an object which is arranged at the rearward end of the motor vehicle, with the object, in particular, being a trailer. The apparatus has sensor means, which are arranged on the motor vehicle, in order to produce sensor signals, which describe the distance between a point on the rear face of the motor vehicle and a point, which is detected by the sensor means, on the trailer face towards the motor vehicle. The evaluation unit uses the detected distance to determine an angle variable, which describes an angle between the longitudinal axis of the trailer and the longitudinal axis of the motor vehicle. Determination of angle variables which characterize the spatial alignment of the trailer relative to the motor vehicle independently of the distance is, in contrast, impossible. In particular it is not possible to detect any rotation of the trailer relative to the motor vehicle about the longitudinal axis of the trailer.

The object of the present invention is thus to develop an apparatus and a method of the type mentioned initially in such a way that the apparatus and the method also allow determination of those angle variables which characterize the spatial alignment of the trailer or semitrailer relative to the prime mover, independently of the distance.

This object is achieved by an apparatus, or a method, for determining a spatial alignment of a semitrailer or trailer which is connected to a prime mover. The apparatus includes sensors and an evaluation unit. The sensors are arranged on the prime mover in order to produce sensor signals which describe the spatial alignment of the semitrailer or trailer relative to the prime mover. The sensors are used to detect contours of the semitrailer or trailer. The evaluation unit uses the sensor signals to determine at least one angle variable which describes an angle between the prime mover and the semitrailer or trailer. The sensor signals include image information from at least one of a two-dimensional representation and an image of a linear sub-area of the detected contours of the semitrailer or trailer. The evaluation unit determines the at least one angle variable on the basis of the image information by evaluating the rate of change of geometric characteristics of the at least one of the two-dimensional representation and the image. The method includes the steps of: (1) detecting contours of the semitrailer or trailer in order to produce sensor signals which describe a spatial alignment of the semitrailer or trailer relative to the prime mover; (2) using the sensor signals to determine at least one angle variable which describes an angle between the prime mover and the semitrailer or trailer, wherein the sensor signals include image information from at least one of a two-dimensional representation and an image of a linear sub-area of the detected contours of the semitrailer or trailer; and (3) determining the at least one angle variable on the basis of the image information by evaluating the rate of change of geometric characteristics of the at least one of the two-dimensional representation and the image of the linear sub-area of the detected contours of the semitrailer or trailer.

The apparatus according to the invention for determining the spatial alignment of a semitrailer or trailer which is connected to a prime mover comprises sensor means, which are arranged on the prime mover, in order to produce sensor signals which describe the spatial alignment of the semitrailer or trailer relative to the prime mover. For this purpose, the sensor means detect contours of the semitrailer or trailer. The sensor signals which are produced by the sensor means include image information from a two-dimensional representation and/or a linear scan of the detected contours of the semitrailer or trailer. An evaluation unit uses the image information to determine at least one angle variable, which describes an angle between the prime mover and the semitrailer or trailer. The contours are in this case defined by boundary surfaces and/or boundary lines of the semitrailer or trailer. Detection of the corresponding boundary surfaces and/or boundary lines of the semitrailer or trailer means that it is also possible to determine those angle variables which characterize the spatial alignment of the semitrailer or trailer relative to the prime mover which are independent of the distance.

The two expressions “two-dimensional representation” and “linear scan” which are used in conjunction with the image information will be explained in the following text. The meaning of the expression “two-dimensional representation” should be understood to be as follows: the spatially pronounced, three-dimensional semitrailer or trailer is detected by suitable sensor means, and a two-dimensional representation is produced from this, for example as in the case of photography. The meaning of the expression a linear scan should be understood as follows: a portion of the spatially pronounced, three-dimensional semitrailer or trailer is scanned. The scanning process can be carried out as follows: the part, which is normally narrow, that is to say linear, strip, is subdivided into a finite number of subregions. Image information is produced for each of these subregions. When combined, these individual image information items result in an image of the linear sub-area of the semitrailer or trailer, comparable to a narrow strip on a photograph. The comparison with photography is intended in the two present cases only for illustrative purposes and is not intended to have any restrictive effect on the technical embodiment.

In order to determine the at least one angle variable, the evaluation unit advantageously evaluates geometric characteristics and/or the rate of change of geometric characteristics of the two-dimensional representation and/or of the linear scan of the detected contours of the semitrailer or trailer. In this case, the at least one angle variable can be determined by use of an image processing program, which is stored in the evaluation unit, so that different angle variables can be determined using one and the same apparatus according to the invention, depending on the image processing program that is used.

The evaluation unit advantageously determines a first angle variable and/or a second angle variable. The first angle variable describes an angle between an axis which is oriented in the longitudinal direction of the prime mover and an axis which is oriented in the longitudinal direction of the semitrailer or trailer. The second angle variable describes an angle between an axis which is oriented in the vertical direction of the prime mover and an axis which is oriented in the vertical direction of the semitrailer or trailer. In this case, the first angle variable may describe the azimuth angle between the longitudinal axis of the prime mover and the longitudinal axis of the semitrailer or trailer. The second angle variable may describe the roll angle and/or the pitch angle between the vertical axis of the prime mover and the vertical axis of the semitrailer or trailer. The roll angle and the azimuth angle, in particular, are major variables for description of the spatial alignment and/or movement of the semitrailer or trailer relative to the prime mover. If the pitch angle is also available, in addition to the roll angle and the azimuth angle, then the spatial alignment of the semitrailer or trailer relative to the prime mover is characterized completely.

Furthermore, it is possible for the evaluation unit to determine a first angle rate variable and/or a second angle rate variable. The first angle rate variable represents the rate of change or derivative of the first angle variable, and the second angle rate variable represents the rate of change or derivative of the second angle variable. The first and the second angle rate variables in this case describe the dynamic response of the semitrailer or trailer relative to the prime mover. The angle rate variables are determined either by calculation by differentiation of the angle variables with respect to time, or by evaluation of geometric characteristics and/or the rate of change of geometric characteristics of the two-dimensional representation, and/or the linear scanning of those contours of the semitrailer or trailer which are detected by the sensor means. In this case, higher-order derivatives with respect to time can also be used, in addition to first-order derivatives with respect to time.

The evaluation unit can use the first angle variable and/or the second angle variable, and/or the first angle rate variable, and/or the second angle rate variable, to determine a mass variable, a mass distribution variable, and/or a center of gravity height variable. The mass distribution variable describes the current mass of the semitrailer or trailer. The mass distribution variable describes the distribution of the mass along an axis which is oriented in the longitudinal direction of the semitrailer or trailer. The center of gravity height variable describes the height of the center of gravity of the semitrailer or trailer. In addition, the sensor signals from a yaw rate sensor, from a lateral acceleration sensor and from wheel rotation speed sensors may be used for the determination of the mass distribution variable. The yaw rate sensor, the lateral acceleration sensor and the wheel rotation speed sensors are, for example, a component of an electronic stability program (ESP) that is provided in the prime mover. Then, in particular, the mass variable and the mass distribution variable can be used to determine the moment of inertia of the semitrailer or trailer with respect to a rotation axis which is oriented in the vertical direction of the semitrailer or trailer.

The mass variable and/or the mass distribution variable and/or the center of gravity height variable determined in this way can advantageously be used to provide driver assistance systems.

It is thus possible for the evaluation unit to determine a threshold value for the first angle variable and/or for the first angle rate variable as a function of the mass variable and of the mass distribution variable. As a result, the evaluation unit can appropriately control drive means and/or braking means and/or steering means for the prime mover and/or braking means on the semitrailer or trailer in order to prevent the magnitude of the first angle variable and/or of the first angle rate variable from exceeding the respectively determined threshold value. The threshold values are determined in such a way that jack-knifing and/or excessive snaking of the vehicle combination comprising the prime mover and the semitrailer or trailer is reliably prevented, or is at least reduced.

Furthermore, the evaluation unit can produce a driver warning in the form of a jack-knifing and/or snaking warning, if the difference between the magnitude of the first angle variable and/or between the magnitude of the first angle rate variable and the respectively determined threshold value is less than a respectively predetermined limit value. By appropriately presetting the limit values, it is possible to produce the driver warning in such a way that the driver has the opportunity to take suitable countermeasures in order to stabilize the vehicle combination, in good time. The driver warning is in this case composed of visual and/or audible and/or tactile warning signals.

In order to counter jack-knifing and/or excessive snaking of the vehicle, combination with better reliability, the evaluation unit determines the threshold value of the first angle variable and/or the threshold value of the first angle rate variable additionally taking into account the instantaneous driving state of the prime mover. The instantaneous driving state of the prime mover is defined, for example, by the speed of travel, the rate of change of the yaw angle and the lateral acceleration of the prime mover, and by the steering angle applied to the steerable wheels of the prime mover. In addition, in order to detect the instantaneous driving state of the prime mover, the evaluation unit can evaluate the operation of a steering wheel which is provided to allow the driver to control the steering angle, of an accelerator pedal which is provided in order to allow the driver to influence the drive means, and a brake pedal which is provided in order to allow the driver to influence the braking means. The braking means may be the braking means of the prime mover and/or the braking means of the semitrailer or trailer.

Corresponding statements apply to the second angle variable and/or the second angle rate variable, with the evaluation unit determining a threshold value for the second angle variable and/or for the second angle rate variable as a function of the mass variable and of the center of gravity height variable. In this case, the threshold values are determined in such a way that rolling over and/or excessive rolling of the vehicle combination are/is reliably prevented or at least reduced. In this case as well, it is possible for the evaluation unit to produce a driver warning in the form of a roll-over or rolling warning, when the difference between the magnitude of the second angle variable and/or between the magnitude of the second angle rate variable and the respectively determined threshold value is less than a respectively predetermined limit value. In the same way as in the case of the determination of the threshold value for the first angle variable and/or the threshold value for the first angle rate variable, the evaluation unit can also in this case take account of the instantaneous driving state of the prime mover in the determination of the threshold value for the second angle variable and/or the threshold value for the second angle rate variable.

Jack-knifing, snaking, roll-over and rolling warnings can in this case be distinguished by the use of different visual and/or audible and/or tactile warning signals for the prime mover driver.

A driver assistance system can also be provided by the evaluation unit determining a nominal value for the first angle variable and/or for the first angle rate variable as a function of the mass variable and of the mass distribution variable, with the evaluation unit appropriately influencing drive means and/or braking means and/or steering means for the prime mover and/or braking means in the semitrailer or trailer in order to allow the first angle variable and/or the first angle rate variable to assume the respectively determined nominal value. In a corresponding manner, it is possible for the evaluation unit to determine a nominal value for the second angle variable and/or for the second angle rate variable as a function of the mass variable and of the center of gravity height variable, with the evaluation unit appropriately influencing drive means and/or braking means and/or steering means for the prime mover, and/or braking means in the semitrailer or trailer, in order to ensure that the second angle variable and/or the second angle rate variable assumes the respectively determined nominal value. The nominal values are preferably determined in such a way that the vehicle combination and/or the semitrailer or trailer have/has a stable driving response at all times while being driven.

In order to ensure that the vehicle combination has a stable driving response even in complex driving situations, the evaluation unit can additionally take into account the instantaneous driving state of the prime mover in the determination of the nominal value of the first angle variable and/or of the nominal value of the first angle rate variable and/or of the nominal value of the second angle variable and/or of the nominal value of the second angle rate variable.

Means are advantageously provided in order to detect the roadway profile, with the evaluation unit taking into account the detected roadway profile in the determination of the nominal value of the first angle variable and/or of the nominal value of the second angle variable and/or of the nominal value of the first angle rate variable and/or of the nominal value of the second angle rate variable. Predictive detection of the roadway profile makes it possible in particular to take into account bends in the direction of travel of the vehicle combination at an early stage in the determination of the nominal values, thus allowing the bends to be driven round safely and comfortably.

Means are advantageously provided for detection of the spatial alignment and/or of the dynamic response of the prime mover relative to the contours of the roadway. The detected spatial alignment and/or the detected dynamic response of the prime mover relative to the contours of the roadway likewise allow/allows the spatial alignment and/or the dynamic response of the vehicle combination and/or of the semitrailer or trailer relative to the contours of the roadway to be determined by taking into account the angle variables and/or the angle rate variables. In this case, incipient rolling-over and/or rolling of the entire vehicle combination can be identified, so that suitable countermeasures can be taken by controlling the drive means and/or braking means and/or steering means of the prime mover and/or the braking means of the semitrailer or trailer. The contours of the roadway are defined by the roadway surface and by roadway boundaries, with the roadway boundary being formed, for example, by the kerb of the roadway surface, by marking applied to the roadway surface and by guides and kerb stones. The means that are used for this purpose may be identical to those means which are provided for detection of the roadway profile.

The sensor means comprise, for example, an arrangement of imaging sensors which are designed to detect electromagnetic waves in the visible or invisible optical wavelength range, or in the radar wavelength range. It is feasible to use, inter alia, conventional CCD cameras, imaging radar sensors or laser scanning apparatuses, with the laser scanning apparatus preferably operating in the infrared wavelength range, thus reducing disturbing external light influences.

The sensor means may be part of an already existing blind angle monitoring device in the prime mover. The blind angle monitoring device is used to monitor areas of the vehicle combination which the driver cannot see directly or through a rear-view mirror arranged on the prime mover (“blind angle”). By way of example, the blind angle monitoring device is used to produce a driver warning on changing lane, if there is another vehicle located in the blind angle of the vehicle combination in the lane to which the change is intended to be made.

In addition to the options for use which have already been described, it is also feasible to use the first angle variable and/or the second angle variable, and/or the first angle rate variable and/or the second angle rate variable, to provide a parking aid and/or a reversing aid.

The apparatus according to the invention will be explained in more detail in the following text with reference to the attached drawings.

### BRIEF DESCRIPTION OF THE DRAWINGS

FIG. 1a shows a vehicle combination which comprises a prime mover and a semitrailer, having sensor means which are arranged on the prime mover and detect the contours of the semitrailer.

FIG. 1b shows a two-dimensional illustration and linear scanning of the contours of the semitrailer which are detected by the sensor means.

FIG. 2 shows a schematically illustrated exemplary embodiment of the apparatus according to the invention.

### DETAILED DESCRIPTION OF THE DRAWINGS

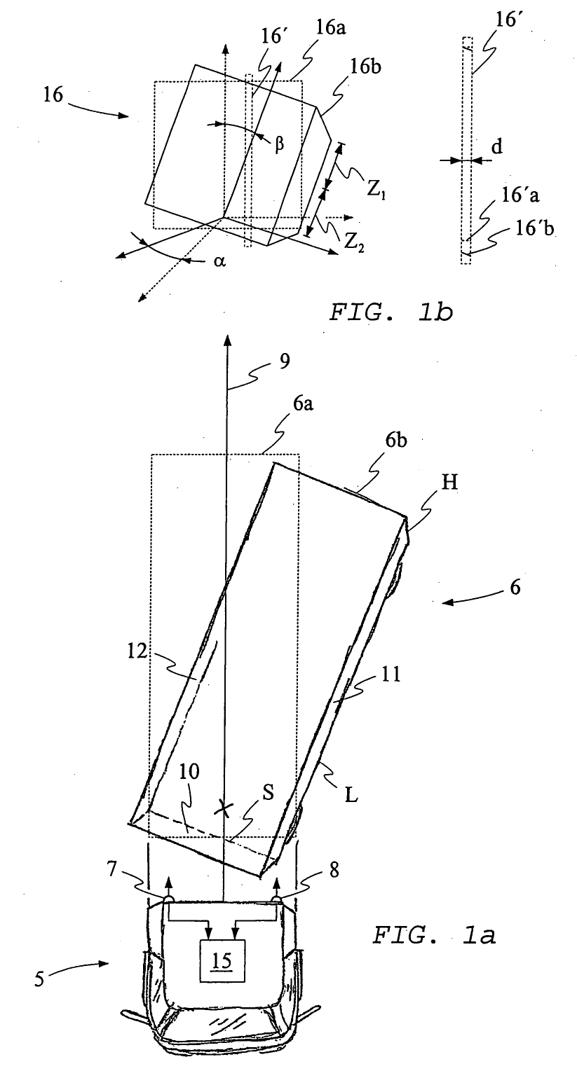

FIG. 1a shows a vehicle combination which comprises a prime mover 5 and a semitrailer 6, although the vehicle combination may also have a trailer instead of the semitrailer 6. By way of example, the semitrailer 6 is shown in a spatial alignment 6b relative to the prime mover 5 that is not its rest position 6a.

Sensor means 7, 8 are arranged on the prime mover 5 in order to detect the contours of the semitrailer 6, for which purpose the sensor means 7, 8 detect boundary surfaces and boundary lines of the semitrailer 6. In the present example, these are the boundary surfaces and boundary lines, detected in the direction of the arrow 9, of the front face 10 and of at least one of the side parts 11, 12 of the semitrailer 6. It is, of course, also feasible to additionally detect the boundary surfaces and boundary lines of the top and bottom of the semitrailer 6. The sensor means 7, 8 produce sensor signals, which include image information relating to a two-dimensional representation 16, as is shown in FIG. 1b, and a linear scan 16′ of the detected boundary surfaces and boundary lines of the semitrailer 6. The two-dimensional representations 16a and 16b as well as the linear scans 16′a and 16′b, respectively, differ depending on the spatial alignment 6a or 6b, respectively, of the semitrailer 6 relative to the prime mover 5. In the end, the linear scan 16′ represents a narrow section of the width d of the two-dimensional representation 16. Depending on the beam width angle of the sensor means 7, 8, the width d may extend from over the range from fractions of a millimeter, through a few millimeters, up to several centimeters.

The spatial alignment of the semitrailer 6 relative to the prime mover 5 is assumed to be characterized in the situation under consideration by definition of a first angle variable, which describes an angle α between an axis which is oriented in the longitudinal direction of the prime mover 5 and an axis which is oriented in the longitudinal direction of the semitrailer 6, and a second angle variable, which describes an angle β between an axis which is oriented in the vertical direction of the prime mover 5 and an axis which is oriented in the vertical direction of the semitrailer 6.

By way of example, the first angle variable describes the azimuth angle between the longitudinal axis of the prime mover 5 and the longitudinal axis of the semitrailer 6, and the second angle variable describes the roll angle and/or the pitch angle between the vertical axis of the prime mover 5 and the vertical axis of the semitrailer 6. In this case, the roll angle describes rotation of the semitrailer 6 about its longitudinal axis, and the pitch angle describes rotation of the semitrailer 6 about its lateral axis, with these rotations being relative to the prime mover 5 in the present case. In the case of a semitrailer 6, the pitch angle is generally negligibly too small in comparison to the roll angle, so that the following text is based on the assumption that the second angle variable is described only by the roll angle.

In order to determine the two angle variables, the sensor signals which are produced by the sensor means 7, 8 are supplied to an evaluation unit 15, which uses the image information that is contained in the sensor signal to evaluate geometric characteristics and/or the rate of change of geometric characteristics of the two-dimensional representation 16 and of the linear scan 16′ of the boundary surfaces and boundary lines of the semitrailer 6 which are detected by the sensor means 7, 8. The geometric characteristics of the two-dimensional representation are characterized, by way of example, by the lengths of the boundary lines, by the ratios of these lengths to one another, by the alignment of the boundary lines, by the alignment of the boundary lines with respect to one another, by the area contents of the boundary surfaces and by the ratios of these area contents to one another.

The evaluation unit 15 thus uses a time sequence of two-dimensional representations 16, which are also referred to as an “optical flow” to determine the semitrailer length L, the semitrailer height sections Z₁, Z₂, which in each case describe the height of the associated rear semitrailer corner relative to the location of the sensor means, and the semitrailer width S. The evaluation unit 15 uses the semitrailer length L, the semitrailer height sections Z₁, Z₂ and the semitrailer width S, together with a state monitor which, for example, is in the form of a Kalman filter, to determine the first angle variable, which describes the azimuth angle of the vehicle combination. The semitrailer height H, in particular, can be determined from the semitrailer height sections Z₁, Z₂. If the sensor means 7, 8 are in the form of an optical system with a focal length f, this must be taken into account in the determination process. The second angle variable, in contrast, can be determined on the basis of a time sequence of linear scans 16′, for which purpose the rate of change of the position of the linearly scanned upper and/or lower boundary line of the front face 10 of the semitrailer 6 is evaluated.

Furthermore, the evaluation unit 15 determines a first angle rate variable and/or a second angle rate variable, with the first angle rate variable representing the rate of change or derivative of the first angle variable, and the second angle rate variable representing the rate of change or derivative of the second angle variable. The angle rate variable is determined either computationally by differentiation of the angle variables with respect to time, or likewise by evaluation of geometric characteristics and/or the rate of change of geometric characteristics of the two-dimensional representation, and/or the linear scan 16′ of the contours of the semitrailer 6 which have been detected by the sensor means 7, 8.

The sensor means 7, 8 are, by way of example, comprise, for example, an arrangement of imaging sensors, which are designed to detect electromagnetic waves in the visible or invisible optical wavelength range. Conventional CCD cameras, imaging radar sensors or laser scanning apparatuses, which scan both horizontally and vertically, that is to say they are imaging apparatus, can be used, inter alia, for the two-dimensional representation 16. In contrast, linear scanning apparatuses which scan only vertically or in only one specific direction can be used for the linear scan 16′. One exemplary embodiment of a suitable laser scanning apparatus is disclosed in the document DE 199 32 779 A1, and the disclosed content of this document is expressly intended to be a component of the present disclosure. In the case of a CCD camera, the focal length of the camera objective that is used is included in the determination of the angle variables and/or of the angle rate variables. In the present example a total of two sensor means 7, 8 are arranged on the prime mover 5, although any other desired number is also feasible.

The sensor means 7, 8 are, in particular, part of an already existing blind-angle monitoring device for the prime mover 5. The blind-angle monitoring device is used to monitor areas of the vehicle combination which the driver cannot see directly or cannot see through a rear-view mirror which is arranged on the prime mover 5, for which purpose the blind angle area which is detected by the sensor means 7, 8 is made visible to the driver, for example, by means of a monitor which is arranged in the prime mover 5.

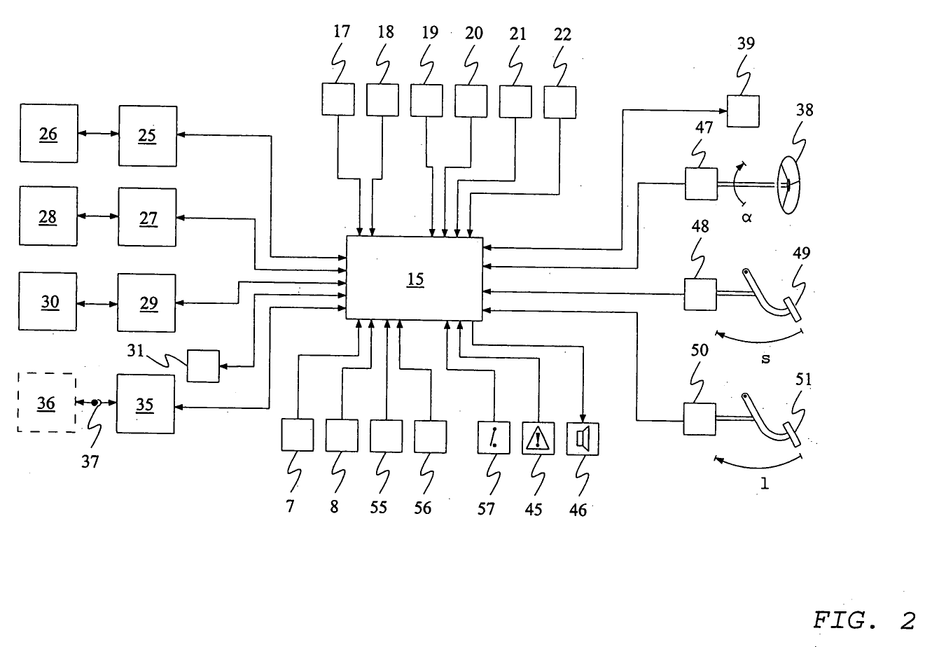

FIG. 2 shows a schematic exemplary embodiment of an apparatus according to the invention. In addition to the sensor means 7, 8 which are arranged on the prime mover 5, the apparatus comprises the evaluation unit 15, to which the sensor signals from the sensor means 7, 8 are supplied in order to determine the first angle variable and/or the second angle variable, and/or the first angle rate variable and/or the second angle rate variable.

The evaluation unit 15 uses the first angle variable and/or the second angle variable, and/or the first angle rate variable and/or the second angle rate variable, to determine a mass variable which describes the current mass of the semitrailer 6, and/or a mass distribution variable, which describes the distribution of the mass along an axis which is oriented in the longitudinal direction of the semitrailer 6, and/or a center of gravity height variable, which describes the height of the central gravity of the semitrailer 6. In this case, the determination of the mass distribution variable can include the signals from a yaw rate sensor 17, which detects the rate of change of the yaw angle of the prime mover 5, from a lateral acceleration sensor 18, which detects the lateral acceleration of the prime mover 5, and from wheel rotation speed sensors 19 to 22, which detect the wheel rotation speeds of the wheels of the prime mover 5. The yaw rate sensor 17, the lateral acceleration sensor 18 on the wheel rotation speed sensors 19 to 22 are, for example, components of an electronic stability program (ESP) which is provided in the prime mover.

The mass variable and/or the mass distribution variable and/or the center of gravity height variable determined in this way form/forms the basis for provision of driver assistance systems, which will be described in the following text.

For this purpose, in addition to a drive means controller 25 for influencing drive means 26 in the prime mover 5, a braking means controller 27 for influencing braking means 28 in the prime mover 5, and a steering means controller 29 for influencing steering means 30 in the prime mover, the apparatus according to the invention also has a braking means controller 35 for influencing braking means 36 in the semitrailer 6. The braking means controller 35 is associated with the prime mover 5, and is connected to the braking means 36 for the semitrailer 6 via a detachable plug connector 37. Alternatively, the braking means controller 35 is arranged in the semitrailer 6.

The steering means 30 comprise a steering angle actuator, which is used to influence the steering angle which can be applied to the steerable wheels of the prime mover 5, while the drive means 26 comprise the propulsion system, which is driven by the drive means controller 25 and comprises the vehicle engine, the transmission and further components, and the braking means 28 and/or the braking means 36, which comprise the braking means controller 27 and/or the braking means controller, which comprise wheel braking devices which are driven by the braking means controller 27 or by the braking means controller 35, respectively, and are respectively intended for braking of the wheels of the prime mover 5 and of the wheels of the semitrailer 6.

Instead of automatically influencing the steering angle by means of the steering angle actuator, it is also feasible to apply steering wheel moments to a steering wheel 38 which is intended for the driver to influence the steering angle, in such a way that the driver is provided with tactile information that the steering angle has been influenced correctly, via the steering wheel 38. The steering wheel moments are applied by means of a steering wheel actuator 39, which interacts with the steering wheel 38 and is driven in a suitable manner by the evaluation unit 15.

In order to provide a driver assistance system, the evaluation unit 15 determines a threshold value for the first angle variable and/or for the first angle rate variable as a function of the mass variable and of the mass distribution variable, with the evaluation unit 15 appropriately influencing drive means 26 and/or braking means 28 and/or steering means 30 for the prime mover 5 and/or braking means 36 in the semitrailer 6 or trailer in order to prevent the magnitude of the first angle variable and/or of the first angle rate variable exceeding the respectively determined threshold value. The threshold values are determined in such a way that jack-knifing and/or excessive snaking of the vehicle combination comprising the prime mover 5 and the semitrailer 6 is prevented and/or at least reduced.

In addition, the evaluation unit 15 produces a driver warning in the form of a jack-knifing and/or snaking warning, when the difference between the magnitude of the first angle variable and/or between the magnitude of the first angle rate variable and the respectively determined threshold value is less than a respectively predetermined limit value. The driver warning is composed of a visual and/or audible and/or tactile warning signals, for which purpose the evaluation unit 15 drives not only the visual signaling means 45 and/or audible signaling means 46, but also possibly the steering wheel actuator 39 in order to produce a tactile warning.

The evaluation unit determines the threshold value of the first angle variable and/or of the first angle rate variable in this case while additionally taking account of the instantaneous driving state of the prime mover 5. The instantaneous driving state of the prime mover 5 is, for example, defined by the speed of travel, the yaw rate and the lateral acceleration of the prime mover 5, as well as by the steering angle which is applied to the steerable wheels of the prime mover, for which purpose the evaluation unit 15 evaluates the signals from the wheel rotation speed sensors 19 to 22, from the yaw rate sensor 17 and from the lateral acceleration sensor 18, as well as the signals from a steering angle sensor 31 which is provided in order to detect the steering angle. In addition, in order to detect the instantaneous driving state of the prime mover 5, the signals are also evaluated from a steering wheel angle sensor 47, which registers the steering wheel angle a selected by the driver on the steering wheel 38, an accelerator pedal sensor 48, which registers the acceleration pedal deflection S of an accelerator pedal 49 which is provided in order to allow the driver to influence the drive means 26, and a brake pedal sensor 50, which registers the brake pedal deflection 1 of a brake pedal 51, which is provided in order to allow the driver to influence the braking means 28, 36.

Corresponding statements apply to the second angle variable and/or to the second angle rate variable, with the evaluation unit 15 determining a threshold value for the second angle variable and/or for the second angle rate variable as a function of the mass variable and of the center of gravity height variable. In this case, the threshold values are determined in such a way that rolling over and/or excessive rolling of the vehicle combination are/is reliably prevented or at least reduced. By appropriately driving the visual signaling means 45 and/or the audible signaling means 46 and/or the steering wheel actuator 39, the evaluation unit 15 produces a driver warning in the form of a roll-over and/or rolling warning when the difference between the magnitude of the second angle variable and/or between the magnitude of the second angle rate variable and the respectively determined threshold value is less than a respectively predetermined limit value. In the same way as for the determination of the threshold value for the first angle variable and/or the threshold value for the first angle rate variable, the evaluation unit 15 also in this case takes into account the instantaneous driving state of the prime mover 5 in the determination of the threshold value for the second angle variable and/or the threshold value for the second angle rate variable.

Furthermore, the evaluation unit 15 determines a nominal value for the first angle variable and/or for the first angle rate variable as a function of the mass variable and of the mass distribution variable, and taking into account the instantaneous driving state of the prime mover 5, with the evaluation unit 15 appropriately influencing the drive means 26 and/or braking means 28 for the primer mover 5 and/or braking means 36 in the semitrailer 6 in order to allow the first angle variable and/or the first angle rate variable to assume the respectively determined nominal value. In a corresponding manner, the evaluation unit 15 determines a nominal value for the second angle variable and/or for the second angle rate variable as a function of the mass variable and of the center of gravity height variable, with the evaluation unit 15 appropriately influencing drive means 26 and/or braking means 28 and/or steering means 30 for the prime mover 5, and/or braking means 36 in the semitrailer 6 or trailer, in order to ensure that the second angle variable and/or the second angle rate variable assumes the respectively determined nominal value. The nominal values are determined in such a way that the vehicle combination and the semitrailer 6 have a stable driving response at all times while driving.

In addition, the evaluation unit 15 takes account of the instantaneous driving state of the prime mover 5 in the determination of the nominal value of the first angle variable and/or of the nominal value of the first angle rate variable and/or of the nominal value of the second angle variable, and/or of the nominal value of the second angle rate variable.

In addition, means 55, 56 are provided for detection of the roadway profile, with the evaluation unit 15 taking into account the detected roadway profile in the determination of the nominal value of the second angle variable and/or of the nominal value of the second angle rate variable. The means 55, 56 detect the roadway profile in a predictive manner, so that, in particular, bends which occur in the direction of travel of the vehicle combination can be taken into account in good time in the determination of the nominal values, so that it is possible to drive round the bends safely and comfortably.

The means 55, 56 are at the same time used to detect the spatial alignment and/or the dynamic response of the prime mover 5, and/or the associated driver's cab relative to the contours of the roadway, for which purpose the means 55, 56 record the immediate surrounding area of the vehicle combination. The evaluation unit 15 uses the detected spatial alignment and/or the detected dynamic response of the prime mover 5 and/or of the associated driver's cab relative to the contours of the roadway, and takes into account the first angle variable and/or the second angle variable and/or the first angle rate variable and/or the second angle rate variable, to determine the spatial alignment and/or the dynamic response of the vehicle combination and/or of the semitrailer 6 relative to the contours of the roadway. The evaluation unit 15 uses the determined spatial alignment and/or the determined dynamic response of the vehicle combination relative to the contours of the roadway surface to identify incipient rolling over and/or rolling of the entire vehicle combination, and takes suitable countermeasures by influencing the drive means 26 and/or the braking means 28 and/or the steering means 30 of the prime mover 5 and/or the braking means 36 for the semitrailer 6. The contours of the roadway are defined by the roadway surface and by roadway boundaries with the latter being formed, for example, by the side boundary of the roadway surface, by markings which are applied to the roadway surface, and by guides and kerb stones. With respect to the design of the means 55, 56, express reference should be made at this point to the document DE 195 07 957 C1, and the disclosed content of this document is expressly intended to be included as a component of the present disclosure. Alternatively or in addition to the use of the means 55, 56, the dynamic response of the prime mover 5 can be determined by evaluation of the signals from the yaw rate sensor 17, from the lateral acceleration sensor 18, from the wheel rotation speed sensors 19 to 22, from the steering wheel angle sensor 47 and from the steering angle sensor 31. The spatial alignment of the prime mover 5 and/or of the associated driver's cab relative to the contours of the roadway detected in this way can be included, in particular, in the determination of the nominal values and threshold values of the angle variables and angle rate variables.

The sensor means 7, 8 are, in particular, part of a blind-angle monitoring device which is provided in the prime mover 5 and is used to monitor areas of the vehicle combination which the driver cannot see directly or via a rear-view mirror which is arranged on the prime mover 5 (“blind angle”).

A further driving assistance system is provided by the evaluation unit 15 influencing the drive means 26 and/or the braking means 28 and/or the steering means 30 of the prime mover 5 and/or the braking means 36 of the semitrailer 6 as a function of the first angle variable and/or of the second angle variable, and/or of the first angle rate variable and/or of the second angle rate variable, in such a way that the driver is provided with assistance for parking and/or for reversing the vehicle combination.

The apparatus according to the invention is activated and deactivated by means of a switch 57, which may be implemented in the form of software in an existing combination menu unit.

1-23. (canceled)

24. An apparatus for determining a spatial alignment of a semi-trailer or trailer which is connected to a prime mover, the apparatus comprising:
sensors which are arranged on the prime mover in order to produce sensor signals which describe the spatial alignment of the semi-trailer or trailer relative to the prime mover, wherein the sensors detect contours of the semi-trailer or trailer; and
an evaluation unit which uses the sensor signals to determine at least one angle variable which describes an angle between the prime mover and the semi-trailer or trailer, wherein the sensor signals include image information from at least one of a two-dimensional representation and an image of a linear sub-area of the detected contours of the semi-trailer or trailer, and wherein the evaluation unit determines the at least one angle variable on the basis of the image information by evaluating the rate of change of geometric characteristics of the at least one of the two-dimensional representation and the image.

25. The apparatus as claimed in claim 24, wherein the at least one angle variable includes at least one of a first angle variable and a second angle variable, wherein the first angle variable describes an angle (α) between an axis which is oriented in the longitudinal direction of the prime mover and an axis which is oriented in the longitudinal direction of the semi-trailer or trailer, and wherein the second angle variable describes an angle (β) between an axis which is oriented in the vertical direction of the prime mover and an axis which is oriented in the vertical direction of the semi-trailer or trailer.

26. The apparatus as claimed in claim 25, wherein the evaluation unit determines at least one of a first angle rate variable and a second angle rate variable, wherein the first angle rate variable represents the rate of change of the first angle variable, and wherein the second angle rate variable represents the rate of change of the second angle variable.

27. The apparatus as claimed in claim 26, wherein the evaluation unit uses at least one of the first angle variable, the second angle variable, the first angle rate variable and the second angle rate variable, to determine a mass variable which describes a current mass of the semi-trailer or trailer.

28. The apparatus as claimed in claim 26, wherein the evaluation unit uses the first angle variable, the second angle variable, the first angle rate variable and the second angle rate variable, to determine a mass distribution variable, which describes a mass distribution along an axis which is oriented in the longitudinal direction of the semi-trailer or trailer.

29. The apparatus as claimed in claim 26, wherein the evaluation unit uses the first angle variable, the second angle variable, the first angle rate variable and the second angle rate variable, to determine a center of gravity height variable, which describes a height of the center of gravity of the semi-trailer or trailer.

30. The apparatus as claimed in claim 25, wherein the evaluation unit uses at least one of the first angle variable, the second angle variable, the first angle rate variable and the second angle rate variable, to determine a mass variable which describes a current mass of the semi-trailer or trailer.

31. The apparatus as claimed in claim 25, wherein the evaluation unit uses the first angle variable, the second angle variable, the first angle rate variable and the second angle rate variable, to determine a mass distribution variable, which describes a mass distribution along an axis which is oriented in the longitudinal direction of the semi-trailer or trailer.

32. The apparatus as claimed in claim 25, wherein the evaluation unit uses the first angle variable, the second angle variable, the first angle rate variable and the second angle rate variable, to determine a center of gravity height variable, which describes a height of the center of gravity of the semi-trailer or trailer.

33. The apparatus as claimed in claim 28, wherein the evaluation unit determines a threshold value for at least one of the first angle variable and the first angle rate variable as a function of the mass variable and of the mass distribution variable, wherein the evaluation unit controls at least one of a drive, a brake and a steering device of the prime mover and a brake of the semi-trailer or trailer, in order to prevent the magnitude of at least one of the first angle variable and the first angle rate variable from exceeding a respective threshold value.

34. The apparatus as claimed in claim 33, wherein the evaluation unit produces a driver warning if at least one of the difference between the magnitude of the first angle variable and its threshold value and the difference between the magnitude of the first angle rate variable and its threshold value is less than a respective predetermined limit value.

35. The apparatus as claimed in claim 27, wherein the evaluation unit determines a threshold value for at least one of the first angle variable and the first angle rate variable as a function of the mass variable and of the mass distribution variable, wherein the evaluation unit controls at least one of a drive, a brake and a steering device of the prime mover and a brake of the semi-trailer or trailer, in order to prevent the magnitude of at least one of the first angle variable and the first angle rate variable from exceeding a respective threshold value.

36. The apparatus as claimed in claim 33, wherein the evaluation unit produces a driver warning if at least one of the difference between the magnitude of the first angle variable and its threshold value and the difference between the magnitude of the first angle rate variable and its threshold value is less than a respective predetermined limit value.

37. The apparatus as claimed in claim 33, wherein the evaluation unit determines at least one of the threshold value for the first angle variable and the threshold value for the first angle rate variable taking into account the instantaneous driving state of the prime mover.

38. The apparatus as claimed in claim 27, wherein the evaluation unit determines a threshold value for at least one of the second angle variable and the second angle rate variable as a function of the mass variable and the center of gravity height variable, wherein the evaluation unit controls at least one of a drive, a brake and a steering device of the prime mover and a brake of the semi-trailer or trailer, in order to prevent at least one of the magnitude of the second angle variable and the magnitude of the second angle rate variable from exceeding a respective threshold value.

39. The apparatus as claimed in claim 38, wherein the evaluation unit produces a driver warning if at least one of the difference between the magnitude of the second angle variable and its threshold value and the difference between the magnitude of the second angle rate variable and its threshold value is less than a respective predetermined limit value.

40. The apparatus as claimed in claim 38, wherein the evaluation unit determines at least one of the threshold value for the second angle variable and the threshold value for the second angle rate variable taking into account the instantaneous driving state of the prime mover.

41. The apparatus as claimed in claim 27, wherein the evaluation unit determines at least one of a nominal value for the first angle variable and a nominal value for the first angle rate variable as a function of the mass variable and the mass distribution variable, and wherein the evaluation unit controls at least one of a drive, a brake and a steering device of the prime mover and a brake of the semi-trailer or trailer, in order to allow at least one of the first angle variable and the first angle rate variable to assume the respective nominal value.

42. The apparatus as claimed in claim 41, wherein the evaluation unit determines at least one of the nominal value for the first angle variable and the nominal value for the first angle rate variable taking into account the instantaneous driving state of the prime mover.

43. The apparatus as claimed in claim 41, further comprising a sensor for detecting a roadway profile, wherein the evaluation unit takes into account the roadway profile in the determination of the at least one of the nominal value of the first angle value and the nominal value of the nominal value of the first angle rate variable.

44. The apparatus as claimed in claim 27, wherein the evaluation unit determines at least one of a nominal value for the second angle variable and a nominal value for the second angle rate variable as a function of the mass variable and the center of gravity height variable, and wherein the evaluation unit controls at least one of a drive, a brake and a steering device of the prime mover and a brake of the semi-trailer or trailer, in order to allow at least one of the second angle variable and the second angle rate variable to assume the respective nominal value.

45. The apparatus as claimed in claim 44, wherein the evaluation unit determines at least one of the nominal value for the second angle variable and the nominal value for the second angle rate variable taking into account the instantaneous driving state of the prime mover.

46. The apparatus as claimed in claim 44, further comprising a sensor for detecting a roadway profile, wherein the evaluation unit takes into account the roadway profile in the determination of the at least one of the nominal value of the second angle value and the nominal value of the nominal value of the second angle rate variable.

47. The apparatus as claimed in claim 25, further comprising sensors for detecting at least one of the spatial alignment and the dynamic response of the prime mover relative to roadway contours, wherein the evaluation unit uses the at least one of the spatial alignment and the dynamic response of the prime mover relative to contours of roadway to determine at least one of the spatial alignment and the dynamic response of at least one of a combination of the prime mover and the semi-trailer or trailer and of the semi-trailer or trailer relative to the roadway contours by taking into account at least one of the first angle variable, the second angle variable, the first angle rate variable and the second angle rate variable.

48. The apparatus as claimed in claim 24, wherein the sensors comprise an arrangement of imaging sensors, which are designed to detect electromagnetic waves in a visible or invisible optical wavelength range or in a radar wavelength range.

49. The apparatus as claimed in claim 24, wherein the sensors are part of a blind-angle monitoring device or of a rear-area monitoring device.

50. The apparatus as claimed in claim 25, wherein at least one of the first angle variable, the second angle variable, the first angle rate variable and the second angle rate variable is used to provide at least one of a parking aid and a reversing aid.

51. A method for determining a spatial alignment of a semi-trailer or trailer which is connected to a prime mover, the method comprising:
detecting contours of the semi-trailer or trailer in order to produce sensor signals which describe a spatial alignment of the semi-trailer or trailer relative to the prime mover;
using the sensor signals to determine at least one angle variable which describes an angle between the prime mover and the semi-trailer or trailer, wherein the sensor signals include image information from at least one of a two-dimensional representation and an image of a linear sub-area of the detected contours of the semi-trailer or trailer; and
determining the at least one angle variable on the basis of the image information by evaluating the rate of change of geometric characteristics of the at least one of the two-dimensional representation and the image of the linear sub-area of the detected contours of the semi-trailer or trailer.
